(19) United States
(12) Patent Application Publication
(10) Pub. No.: US 2026/0078260 A1
(43) Pub. Date: Mar. 19, 2026

(54) NEAR-INFRARED REFLECTIVE CARBON BLACK

(71) Applicant: BIRLA CARBON U.S.A., Marietta, GA (US)

(72) Inventors: Yuanhao Guo, Marietta, GA (US); Ranjan Kumar Kamat, Kennesaw, GA (US); Douglas Barr, Monroe, GA (US)

(21) Appl. No.: 19/108,860

(22) PCT Filed: Sep. 7, 2023
(86) PCT No.: PCT/US2023/032132

§ 371 Date: Mar. 5, 2025

Related U.S. Application Data
(60) Provisional application No. 63/404,346, filed on Sep. 7, 2022.

(51) Int. Cl. C09C 1/56; C09C 3/06

(52) U.S. Cl. CPC C09C 1/56; C09C 3/063; C01P 2002/72; C01P 2002/85; C01P 2004/04; C01P 2004/61; C01P 2004/62; C01P 2004/80; C01P 2006/12; C01P 2006/19; C01P 2006/60

(57) ABSTRACT

A near-infrared reflective carbon black composite comprising carbon black and TiO2 coating and a method for making of carbon black composite are disclosed. The method comprises providing a dispersion of a carbon black in a solvent; mixing the dispersion with water and a TiO2 precursor under conditions sufficient to form an oligomer coating comprising a Ti compound on at least a portion of the surface of the carbon black, wherein the TiO2 precursor is at least partially soluble in the solvent; and converting the oligomer coating comprising the Ti compound to TiO2 to form the carbon black composite.

### CROSS-REFERENCE TO RELATED APPLICATIONS

This application claims priority to U.S. Provisional Application No. 63/404,346, filed Sep. 7, 2022, the entirety of which is incorporated into this application by reference.

### BACKGROUND

Carbon black is widely used in the dark colored applications for plastics, coatings, and paint due to its high jetness, high UV absorbability, color stability, and low cost. However, carbon black absorbs over 95% near-infrared (“NIR”) light spectrum ranging from 700 nm to 2500 nm, which makes carbon black unfavorable for certain applications. Plastic containing carbon black, for example, tends to have over 40° C. heat build-up above ambient temperature under sun light (55% of solar energy is in the NIR range) due to the high NIR absorption of carbon black. The high heat build-up leads to the urban heat island effect, warpage, distortion, and shrinkage of plastic components.

Moreover, as autonomous vehicles become one of the primary mobility trends, light detection and ranging (LiDAR) sensors will play a larger role in the vehicle market. The LiDAR sensor maps the 3D environment by detecting radiation reflected from surroundings. Since the wavelength (905 nm or 1550 nm) of LiDAR radiation is within the NIR region, carbon black colored coatings on vehicles lead to low sensitivity for LiDAR sensors, which may cause potential traffic accidents and safety concerns.

Additionally, NIR sorting devices are used in plastic recycling process, and the plastics containing 0.05% carbon black are not sortable due to too much absorption of NIR signal. Carbon black may be avoided by downstream manufactures considering the sustainability and carbon footprint reduction of plastics. It is essential to improve the NIR reflectance of carbon black.

The nature of high NIR absorption for carbon black cannot be changed without modification. Physical blends of TiO₂ and carbon black show similar level of NIR reflectance relative pure carbon black. A very small amount of pure carbon black in a plastic or coating can lead to high heat build-up. Current dark color NIR colorant technologies include NIR reflective pigments, NIR transparent pigments, and dyes. However, these technologies have their own limitations and disadvantages. The chemistry of NIR reflective pigments is complex. NIR reflective pigments generally show low jetness and poor color stability. The transition metal elements cause the accelerated degradation of plastics such as PVC. Additionally, the cost of NIR transparent pigments is high (about $100/lb). NIR transparent dye also has poor color stability and is suitable only for limited plastics. To make an entire system NIR reflective, the NIR transparent pigment and dye need to be coupled with a NIR reflective substrate, which adds complexity and additional cost.

### SUMMARY

This disclosure relates to a TiO₂ coated carbon black, which retains advantages of carbon black including its high jetness, color stability, and low cost, while achieving significantly improved NIR reflectance relative to pure carbon black and physical carbon black/titanium dioxide blends.

In one aspect, the near-infrared reflective carbon black composite can comprise a carbon black and a TiO₂ layer at least partially coating the carbon black.

In one aspect, the method for making the carbon black composite can comprise providing a carbon black having an oligomer coating comprising a Ti compound on at least a portion of the surface of the carbon black; and converting the oligomer coating comprising the Ti compound to TiO₂ to form the carbon black composite.

In another aspect, the method for making the carbon black composite can comprise providing a dispersion of a carbon black in a solvent; mixing the dispersion with water and a TiO₂ precursor under conditions sufficient to form an oligomer coating comprising a Ti compound on at least a portion of the surface of the carbon black, wherein the TiO₂ precursor is at least partially soluble in the solvent; and converting the oligomer coating comprising the Ti compound to TiO₂ to form the carbon black composite.

Also described are coatings, e.g., automotive top coats, plastics, and other articles comprising the near-infrared carbon black composites and the carbon black composites prepared according to the described methods.

### BRIEF DESCRIPTION OF THE DRAWINGS

The foregoing summary, as well as the following description of the disclosure, is better understood when read in conjunction with the appended drawings. For the purpose of illustrating the disclosure, the drawings illustrate some, but not all, alternative embodiments. This disclosure is not limited to the precise arrangements and instrumentalities shown. The following figures, which are incorporated into and constitute part of the specification, assist in explaining the principles of the disclosure.

FIG. 1 is an exemplary process for modifying the surface of carbon black with a layer of TiO₂.

FIG. 2 is a scheme showing TiO, synthesis from titanium ethoxide.

FIG. 3 shows TEM morphology of exemplary-Ti—O—Ti— oligomer coated RAVEN 1080 ULTRA (“R1080U”) powders with 37% TiO₂.

FIG. 4 shows a TEM image and corresponding EDS analysis of exemplary-Ti—O—Ti— oligomer coated RAVEN 1080 ULTRA (“R1080U”) powders (Example 3).

FIG. 5 shows TEM morphology of exemplary TiO₂ coated RAVEN 1080 ULTRA (“R1080U”) powders with 37% TiO₂ (Example 2).

FIG. 6 shows a TEM image and corresponding EDS analysis of exemplary TiO₂ coated RAVEN 1080 ULTRA (“R1080U”) powders (Example 2).

FIG. 7 shows XRD patterns of exemplary TiO₂ coated RAVEN 1080 ULTRA (“R1080U”).

FIG. 8 shows TEM morphology of exemplary TiO₂ coated RAVEN 1080 ULTRA (“R1080U”) powders with 46% TiO₂ (Example 3).

FIG. 9 shows absolute reflectance % of pure RAVEN 1080 ULTRA (“R1080U”), TiO₂ coated RAVEN 1080 ULTRA (“R1080U”), and R1080/T595 physical blend from 300 nm to 2500 nm.

FIG. 10 shows Rutile TiO₂ XRD patterns for Example 8.

FIG. 11 shows absolute reflectance % for Examples 5-11 from 300 nm to 2500 nm.

### DETAILED DESCRIPTION

### A. Definitions

When the term “about” precedes a numerical value, the numerical value can vary within +10% unless specified otherwise.

“Nitrogen surface area (NSA)” and “statistical thickness surface area (STSA)” refers to nitrogen surface area and statistical thickness surface area as measured according to ASTM Test Method D6556, which is incorporated by reference.

“Iodine absorption number” refers to iodine absorption values as measured according to ASTM D1510.

“Oil absorption number (OAN)” refers to oil absorption values as measured according to ASTM D2414.

“Compressed oil absorption number (COAN)” refers to compressed oil absorption values as measured according to ASTM D3493.

“325 mesh water wash residue” refers to residue values as measured according to ASTM D1514.

All the above-described ASTM methods are incorporated by reference in their entireties.

### B. Near-IR Reflective Carbon Blacks

In one aspect, the near-infrared reflective carbon black composite comprises a carbon black and a TiO₂ layer at least partially coating the carbon black. The composite is not limited to any particular type of carbon black. In one aspect, carbon blacks useful in paints, automotive top coats, plastics, and the like can be used. In a further aspect, the carbon black has an oil absorption number (OAN) ranging from 45-260 cm³/100 g. In a further aspect, the carbon black has a nitrogen surface area (NSA) ranging from 25-600 m²/g.

The carbon black can be produced by any suitable method. In one aspect, the carbon black is produced by a furnace black process, a lampblack process, a channel black process, a thermal black process, an acetylene black process, or a microwave plasma process. In a further aspect, the carbon black has been heat treated, chemically treated, ozone treated, or acid treated.

In one aspect, the composite retains useful properties of carbon black while imparting near-IR reflectivity to the composition. Thus, in some aspects, the composite can be free of metals that typically cause degradation of coatings and plastics, including transitions metals other than Ti, e.g., chromium and iron.

The thickness of the TiO₂ layer can vary. In one aspect, the TiO₂ layer has an average thickness ranging from 0.5 nm to 200 nm. In a further aspect, the TiO₂ layer has an average thickness ranging from 0.5 nm to 20 nm, e.g., 0.5 nm to 15 nm. In one aspect, the TiO₂ layer coats a portion of the carbon black, with some carbon black surface not being coated with the TiO₂ layer. In a further aspect, the TiO₂ layer coats the entire surface of the carbon black. The composite can have a range of median particle sizes, e.g., ranging from 0.1 μm to 5 μm.

In one aspect, the method for making the carbon black composite comprises: providing a carbon black having an oligomer coating comprising a Ti compound on at least a portion of the surface of the carbon black; and converting the oligomer coating comprising the Ti compound to TiO₂ to form the carbon black composite. In one aspect, the Ti compound is formed from a TiO₂ precursor such as a titanium alkoxide, e.g., titanium ethoxide, titanium propoxide, titanium isopropoxide, titanium butoxide, or a mixture thereof. In a further aspect, the Ti compound is formed from a TiO₂ precursory such as a titanium sulphate, a titanium oxychloride, a titanium tetrachloride, a titanium (III) chloride, or a mixture thereof.

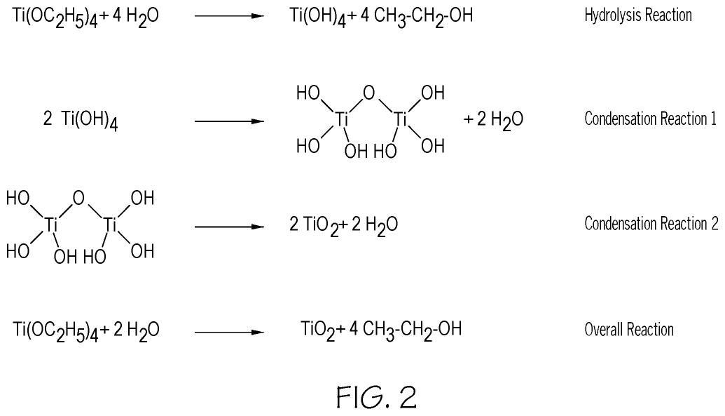

In a further aspect, the Ti compound is a condensation product of a titanic acid. For example, a TiO₂ precursor such as a titanium alkoxide can hydrolyze in the presence of water to form a titanic acid such as titanium hydroxide, which can then be condensed to form the Ti compound, which in the case of titanium hydroxide will be the condensation reaction product shown in Reaction 1 of FIG. 2. This condensation product can then be converted to TiO₂ through various means such as calcination in a pyrolysis chamber. Similar hydrolysis and condensation reactions can be performed on a titanium sulphate, a titanium oxychloride, a titanium tetrachloride, a titanium (III) chloride, or a mixture thereof, to provide the Ti compound.

In a further aspect, the method for making the composite comprises providing a dispersion of a carbon black in a solvent; mixing the dispersion with water and a TiO₂ precursor under conditions sufficient to form an oligomer coating comprising a Ti compound on at least a portion of the surface of the carbon black, wherein the TiO₂ precursor is at least partially soluble in the solvent; and converting the oligomer coating comprising the Ti compound to TiO₂ to form the carbon black composite.

A small amount of water added to the carbon black dispersion can allow the TiO₂ to sufficiently hydrolyze into the oligomer compound. e.g., a titanic acid. In one aspect, the molar ratio of water to TiO₂ precursor ranges from 2:1 to 10:1. In a further aspect, the molar ratio of water to TiO₂ precursor is about 3:1.

The solvent can be any solvent capable of at least partially dissolving the TiO₂ such that the precursor can react to form the oligomer compound which can in turn be converted into the TiO₂ layer. For titanium alkoxides such as titanium ethoxide for example, a suitable solvent is an organic hydrocarbon solvent such as pentane, heptane, and the like.

### C. Exemplary Embodiments

The following embodiments are exemplary, specific embodiments of the disclosure.

(1) A near-infrared reflective carbon black composite comprising a carbon black and a TiO₂ layer at least partially coating the carbon black.

(2) The composite of embodiment (1), wherein the carbon black has an oil absorption number (OAN) ranging from 45-260 cm³/100 g.

(3) The composite of embodiment (1) or (2), wherein the carbon black has a nitrogen surface area (NSA) ranging from 25-600 m²/g.

(4) The composite of any preceding embodiment, which is free of transition metals other than Ti.

(5) The composite of any preceding embodiment, which is free of iron and chromium.

(6) The composite of any preceding embodiment, wherein the TiO₂ layer has an average thickness ranging from 0.5 nm to 200 nm.

(7) The composite of any preceding embodiment, wherein the TiO₂ layer has an average thickness ranging from 0.5 nm to 20 nm.

(8) The composite of any preceding embodiment, having a median particle size ranging from 0.1 μm to 5 μm.

(9) The composite of any preceding embodiment, wherein the carbon black is produced by a furnace black process, a lampblack process, a channel black process, a thermal black process, an acetylene black process, or a microwave plasma process.

(10) The composite of any preceding embodiment, wherein the carbon black has been heat treated, chemically treated, ozone treated, or acid treated.

(11) A method for making a carbon black composite, the method comprising: a) providing a carbon black having an oligomer coating comprising a Ti compound on at least a portion of the surface of the carbon black; and b) converting the oligomer coating comprising the Ti compound to TiO₂ to form the carbon black composite.

(12) The method of embodiment (11), wherein the carbon black is produced by a furnace black process, a lampblack process, a channel black process, a thermal black process, an acetylene black process, or a microwave plasma process.

(13) The method of embodiment (11) or (12), wherein the carbon black has been heat treated, chemically treated, ozone treated, or acid treated.

(14) The method of any of embodiments (11)-(13), wherein the Ti compound is formed from TiO₂ precursor.

(15) The method of embodiment (14), wherein the TiO₂ precursor is a titanium alkoxide.

(16) The method of embodiment (15), wherein the titanium alkoxide is titanium ethoxide, titanium propoxide, titanium isopropoxide, titanium butoxide, or a mixture thereof.

(17) The method of embodiment (11), wherein the Ti compound is prepared from a titanium sulphate, a titanium oxychloride, a titanium tetrachloride, a titanium (III) chloride, or a mixture thereof.

(18) The method of any of embodiments (11)-(14), wherein the Ti compound is a condensation product of a titanic acid.

(19) A method for making a carbon black composite, the method comprising: a) providing a dispersion of a carbon black in a solvent; b) mixing the dispersion with water and a TiO₂ precursor under conditions sufficient to form an oligomer coating comprising a Ti compound on at least a portion of the surface of the carbon black, wherein the TiO₂ precursor is at least partially soluble in the solvent; and c) converting the oligomer coating comprising the Ti compound to TiO₂ to form the carbon black composite.

(20) The method of embodiment (19), wherein the carbon black is produced by a furnace black process, a lampblack process, a channel black process, a thermal black process, an acetylene black process, or a microwave plasma process.

(21) The method of embodiment (19) or (20), wherein the carbon black has been heat treated, chemically treated, ozone treated, or acid treated.

(22) The method of any one of embodiments (19)-(21), wherein the TiO₂ precursor is a titanium alkoxide.

(23) The method of embodiment (22), wherein the titanium alkoxide is titanium ethoxide, titanium propoxide, titanium isopropoxide, titanium butoxide, or a mixture thereof.

(24) The method of any of embodiments (19)-(21), wherein the TiO₂ precursor is a titanium sulphate, a titanium oxychloride, a titanium tetrachloride, a titanium (III) chloride, or a mixture thereof.

(25) The method of any of embodiments (19)-(24), wherein the molar ratio of water to TiO₂ precursor ranges from 2:1 to 10:1.

(26) The method of any of embodiments (19)-(25), wherein the molar ratio of water to TiO₂ precursor is about 3:1.

(27) The method of any of embodiments (19)-(26), wherein the Ti compound is a condensation product of a titanic acid.

### D. Examples

The following Examples further illustrate this disclosure. The scope of the disclosure and claims is not limited by the scope of the following Examples.

Examples shown in Table 1 were prepared according to the following procedure.

TABLE 1
Samples

| Sample | |
|---|---|
| Number | Sample Description |
| Example 1 | Raven 1080U Powder |
| Example 2 | Raven 1080U - TiO₂ Nanocoat - 37% |
| A-106073 | —Ti—O—Ti— Oligomer Coated Raven 1080U |
| Example 3 | Raven 1080U - TiO₂ Nanocoat - 46% |
| Example 4 | Raven 1080/T595 - 46% |
| Example 5 | RAVEN 1080 ULTRA (“R1080U”) |
| Example 6 | Anatase TiO₂ grafted RAVEN 1080 ULTRA |
| | (“R1080U”)-80% |
| Example 7 | physical blend of RAVEN 1080 ULTRA |
| | (“R1080U”)/anatase TiO₂-80% |
| Example 8 | Rutile TiO₂ grafted RAVEN 1080 ULTRA |
| | (“R1080U”)-80%, |
| Example 9 | Physical blend of RAVEN 1080 ULTRA |
| | (“R1080U”)/rutile TiO₂-80% |
| Example 10 | Anatase TiO₂ grafted RAVEN 1080 ULTRA |
| | (“R1080U”)-90% |
| Example 11 | Physical blend of RAVEN 1080 ULTRA |
| | (“R1080U”)/anatase TiO₂-90% |

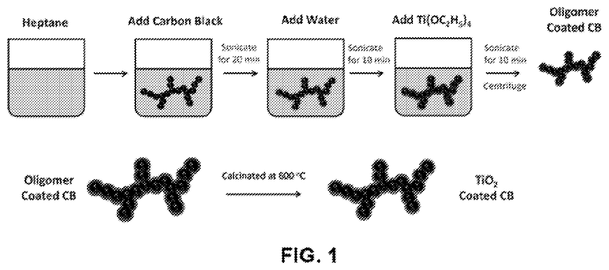

General Procedure: The surface of carbon black was modified by TiO₂ following the procedure shown in FIG. 1. Nitrogen gas was used to purge the moisture out of a 100 mL polypropylene (PP) bottle for 30 min. The PP bottle was filled with 50 mL of heptane, and 100 mg of RAVEN 1080 ULTRA (“R1080U”) powder was added into the heptane. The sonication probe was inserted into heptane/RAVEN 1080 ULTRA (“R1080U”) mixture to disperse the carbon black. The mixture was sonicated for 20 min with the intensity and cycle set as 5 and 8, respectively. A small amount of water was added into the heptane/RAVEN 1080 ULTRA (“R1080U”) dispersion, and the dispersion was sonicated vigorously for 15 min after adding water.

The calculated amount of titanium ethoxide (“TEO”) was dissolved in 20 mL heptane in a vial. The amount of added water and TEO can be found in Table 2. The TEO/heptane solution was pipetted into the PP bottle with the heptane/RAVEN 1080 ULTRA (“R1080U”) dispersion while sonication was on. The dispersion was sonicated for 10 min to allow the hydrolysis and condensation reaction of TEO as shown in FIG. 2. After the reaction was completed, the oligomer coated RAVEN 1080 ULTRA (“R1080U”) powders were collected using centrifuge and dried in the chemical hood. —Ti—O—Ti— oligomer coated RAVEN 1080 ULTRA (“R1080U”) powders was heat treated at 600° C. under nitrogen for 1 hour in a pyrolysis chamber. The oligomer was transformed to anatase phase TiO₂ after the heat treatment. The percentage of TiO₂ in the modified RAVEN 1080 ULTRA (“R1080U”) was analyzed by TGA by heating to 800° C. at 10° C./min under air condition. The morphology and element composition were characterized by TEM and EDAX as shown in Table 3. The NIR reflectance % of the powders was tested by UV-Vis-NIR spectrometer.

TABLE 2
Ratio of H₂O/TEO and TiO₂ % in the modified RAVEN 1080 ULTRA (“R1080U”)

| | | R1080U | Water | Water film | Actual | Calculated TiO₂ % |
|---|---|---|---|---|---|---|
| | H₂O/TEO | Mass | added | thickness | Stoichiometric | in modified |
| Example | mol ratio | (mg) | (ul) | (nm) | TEO added (g) | R1080U |
| Example 2 | 2:1 | 100 | 35 | 3.89 | 0.245 | 46.7 |
| Example 3 | 3:1 | 100 | 55 | 6.11 | 0.244 | 46.1 |

TABLE 3
Testing Method

| Test | Method | Test | Method |
|---|---|---|---|
| TGA-SPECIA | | XRD | LS5-XRD |
| TEM Micrograph | LS5-302 | NIR Reflectance | |
| EDAX | | | |

Procedure to prepare samples for Example 1: The RAVEN 1080 ULTRA carbon (“R1080U”) powder was produced from furnace carbon black process and treated with Ozone.

Procedure to prepare pigment samples for Examples 2, 3, 6, 8, and 10: The polypropylene (PP) bottle was filled with 50 mL heptane, and 100 mg of RAVEN 1080 ULTRA carbon (“R1080U”) black powder was added into heptane. The RAVEN 1080 ULTRA (“R1080U”) carbon black powder was dispersed in the heptane by inserting a sonication probe for 20 minutes. A small amount of water was added into the heptane/RAVEN 1080 ULTRA (“R1080U”) dispersion, and the dispersion was sonicated vigorously for 15 min after adding water. The calculated amount of titanium ethoxide (TEO) was dissolved in 20 ml heptane in a vial. The TEO/heptane solution was pipetted into the PP bottle with the heptane/RAVEN 1080 ULTRA (“R1080U”) powder dispersion while sonication was on. The dispersion was sonicated for 10 min to allow the hydrolysis and condensation reaction of TEO. After the reaction was completed, the oligomer coated RAVEN 1080 ULTRA (“R1080U”) powders were collected using centrifuge and dried in the chemical hood. The oligomer grafted RAVEN 1080 ULTRA (“R1080U”) powders was heat treated at 600° C. and 900° C. under nitrogen for 1 hour in the pyrolysis chamber to form anatase and rutile TiO₂, respectively.

Procedure to prepare samples for Example 4: The commercial grade TiO₂ of TIONA® 595 was purchased from Tronox and used as it was received. The physical blend of RAVEN 1080 ULTRA (“R1080U”)/T595 was prepared by blending with RAVEN 1080 ULTRA (“R1080U”) and T595 with the mass ratio of 54/46.

Procedure to prepare pigment samples for Examples 7 and 10: The physical blends of RAVEN 1080 ULTRA (“R1080U”)/anatase TiO₂ were prepared by blending anatase TiO₂ and RAVEN 1080 ULTRA (“R1080U”) with the mass ratio of 80/20 and 90/10, respectively.

Procedure to prepare pigment samples for Example 9: The physical blends of RAVEN 1080 ULTRA (“R1080U”)/rutile TiO₂ were prepared by blending rutile TiO₂ and RAVEN 1080 ULTRA (“R1080U”) with the mass ratio of 80/20.

Procedure to prepare acrylic coating samples for Examples 5-11: The pigments were dispersed in the acrylic enamel recipe using Lau paint shaker. The coating was prepared using drawdown applicator, and air dried for 30 minutes followed with 15 minutes curing at 110° C.

Procedure to prepare samples for conductivity test: Test samples, 1 mm×2.54 cm tape strands, were prepared using a tape header on a twin-screw extruder.

Procedure to test NIR reflectance %: The NIR reflectance % was measured from 300 nm to 2500 nm by Perkin Elmer Lambda 1050.

Procedure to characterize morphology: the morphology of TiO₂ coated RAVEN 1080 ULTRA (“R1080U”) was characterized by TEM.

Procedure to evaluate element compositions and crystal structures: The element compositions and crystal structures of TiO₂ coating on the surface of RAVEN 1080 ULTRA (“R1080U”) were characterize by EDAX analysis and XRD.

The ratio of H₂O/TEO had an effect on the TiO₂ percentage in the modified RAVEN 1080 ULTRA (“R1080U”). As the H₂O/TEO ratio was 2:1 based on their ratio in the overall reaction in FIG. 2, the calculated TiO₂% should be 47.7% as shown in Table 2. However, the actual TiO₂% in Example 2 was found to be 36.8% as shown in Table 4, which was caused by insufficient water. Because the reactions occurred after pipetting TEO were the hydrolysis reaction and condensation reaction 1, and the ratio of H₂O/TEO of these two combined reactions should be 3:1. Therefore, there was not enough water for TEO to react with and the unreacted TEO residuals in the heptane were discarded during the centrifuge process. As a result, the actual TiO₂% in Example 2 was lower than the calculated percentage. When the H₂O/TEO ratio was increased to 3:1, the actual TiO₂% analyzed by TGA is 46.6% and it matched well with the calculated TiO₂% in the Example 3. Therefore, TEO was fully transformed into TiO₂ as the H₂O/TEO ratio was 3:1.

TABLE 4
Actual TiO₂% in modified RAVEN 1080 ULTRA (“R1080U”) powders
analyzed by TGA

| | | Actual TiO₂% in |
|---|---|---|
| Sample | Description | modified R1080U |
| Example 1 | R1080U | 0 |
| Example 2 | Anatase TiO₂ grafted | 36.8% |
| | R1080U - 37% | |
| Example 3 | Anatase TiO₂ grafted | 46.6% |
| | R1080U - 46% | |
| Example 4 | Physical Blend of | 45.8% |
| | R1080U/T595 - 46% | |

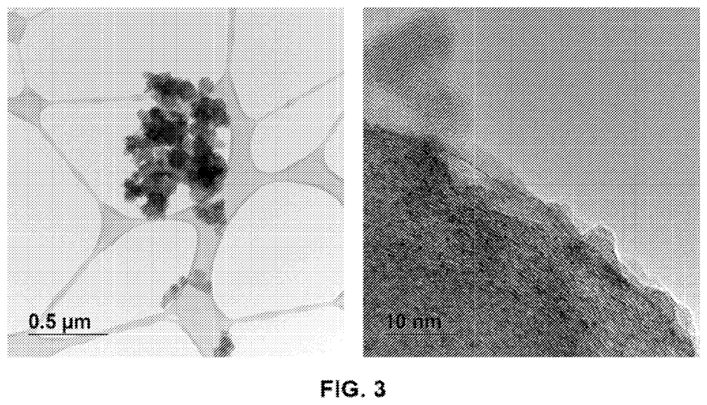

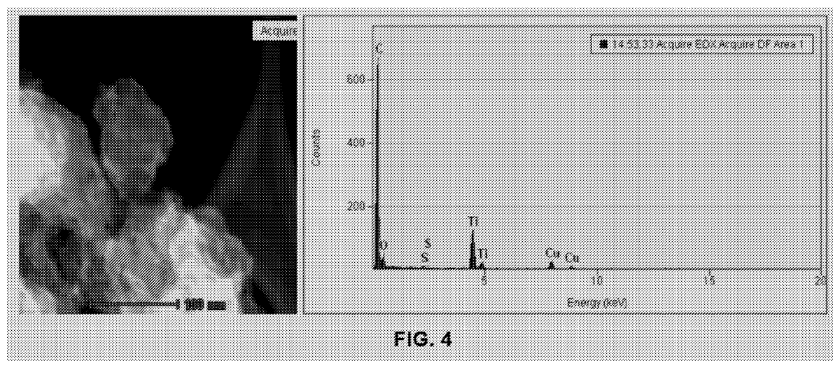

The surface of RAVEN 1080 ULTRA (“R1080U”) powder was modified successfully via the hydrolysis and condensation reaction of TEO as revealed by the TEM images in FIG. 3. There was a layer of —Ti—O—Ti— oligomer nanocoating observed on the surface of RAVEN 1080 ULTRA (“R1080U”) powder. The thickness of —Ti—O—Ti— oligomer nanocoating varied from 1 nm to 17 nm. According to the EDAX analysis in FIG. 4, the modified RAVEN 1080 ULTRA (“R1080U”) is composed of C, Ti and O, which confirmed the deposition of —Ti—O—Ti— oligomer on the surface of RAVEN 1080 ULTRA (“R1080U”).

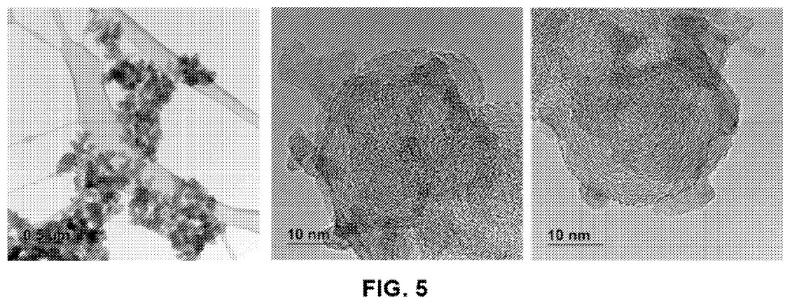

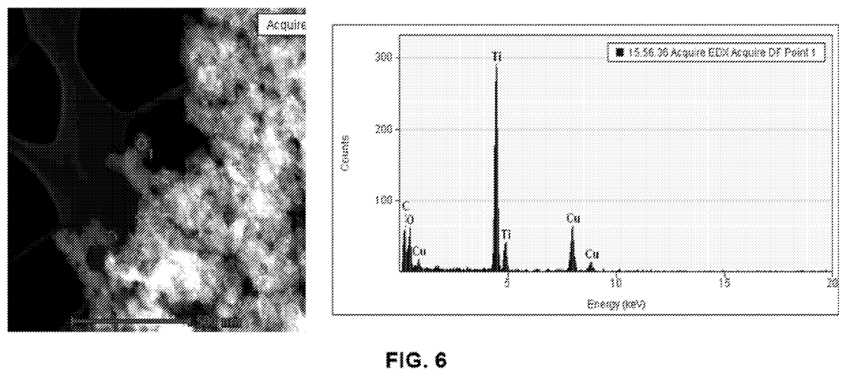

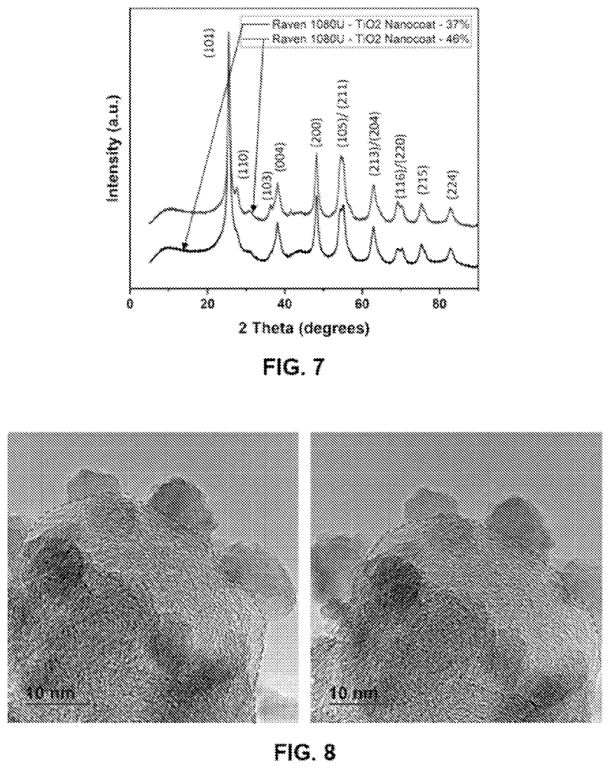

The —Ti—O—Ti— oligomer coated RAVEN 1080 ULTRA (“R1080U”) was calcined at 600° C. for 1 hour under nitrogen, and the oligomer was transformed to TiO, according to the condensation reaction 2 in FIG. 2. The TEM images in FIG. 5 show that the surface of RAVEN 1080 ULTRA (“R1080U”) was coated with a layer of TiO₂. The thickness of the TiO₂ shell in Example 2 ranges from 0.7 nm to 12.5 nm. There were also exposed surfaces without TiO₂ nanocoating. The EDAX analysis in FIG. 6 confirms the composition of modified RAVEN 1080 ULTRA (“R1080U”) containing C, Ti and O. The XRD patterns in FIG. 7 confirm the transition from —Ti—O—Ti— oligomer to anatase phase TiO₂ after heat treatment. Similarly, TiO₂ nanocoating was observed on the RAVEN 1080 ULTRA (“R1080U”) for Example 3 with a higher percentage of TiO₂ (46%) in FIG. 8. Comparing with Example 2, the thickness of the coating became more uniform ranging from 0.8 to 7 nm. More surfaces of RAVEN 1080 ULTRA (“R1080U”) were covered by TiO₂ nanocoating in Example 3 due to higher TiO₂ percentage.

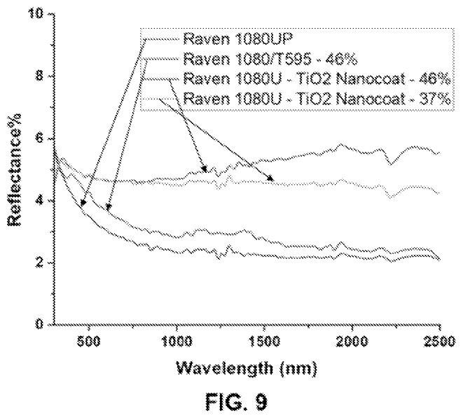

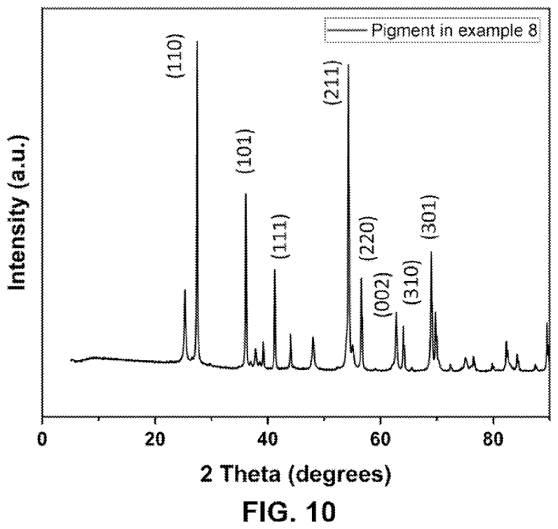

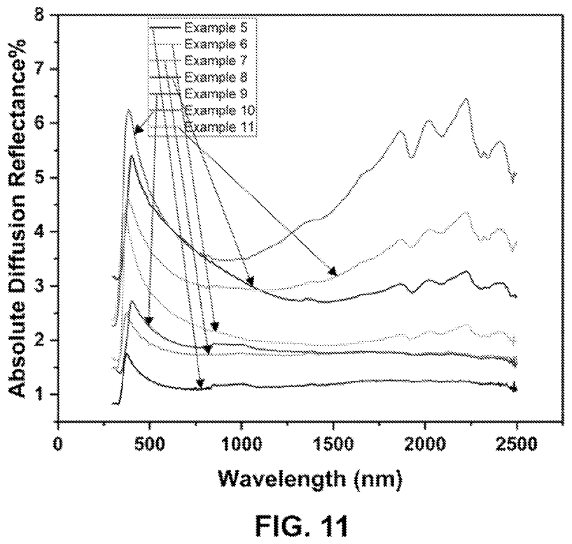

The spectrum reflectance % of the TiO₂ coated RAVEN 1080 ULTRA (“R1080U”) samples were characterized by UV-Vis-NIR spectrometer ranging from 300 nm to 2500 nm in FIG. 9. Their results were compared against the pure RAVEN 1080 ULTRA (“R1080U”) control and physical blends of RAVEN 1080 ULTRA (“R1080U”) and Tiona 595 (T595: a commercial grade of TiO₂ for coating and plastic). In the NIR range from 700 nm to 2500 nm, carbon black showed only 2.08-2.43% of reflectance % due to the high NIR absorption nature of carbon black. The NIR reflectance % of TiO₂ coated RAVEN 1080 ULTRA (“R1080U”) was enhanced significantly over 1.5 times as RAVEN 1080 ULTRA (“R1080U”) was partially covered by TiO, nanocoating with extremely high NIR reflection ability. The NIR reflectance % was increased with the percentage of TiO₂ nanocoating. Although the physical blends of RAVEN 1080 ULTRA (“R1080U”) and T595 contained 45.8% TiO₂, less than 20% improvement of NIR reflectance % was observed as the surface of T595 was covered by RAVEN 1080 ULTRA (“R1080U”) powder. Since the wavelength of LiDAR signal is located at 905 and 1550 nm, the NIR reflectance % and percentage of improvement at these two wavelengths as well as 2000 and 2500 nm was summarized in Tables 5 and 6, respectively. They showed that TiO₂ nanocoated RAVEN 1080 ULTRA (“R1080U”) achieved more than 150% higher NIR reflectance % than the RAVEN 1080 ULTRA (“R1080U”). The TiO₂ nanocoated carbon black showed much more effective improvement of NIR reflectance % than physical blends of carbon black and TiO₂.

TABLE 5
NIR Reflectance % at Specific Wavelengths

| Example | Description | 905 nm | 1550 nm | 2000 nm |
|---|---|---|---|---|
| Example 1 | RAVEN 1080 ULTRA | 2.43 | 2.23 | 2.21 |
| | (“R1080U”) | | | |
| Example 2 | Anatase TiO₂ grafted | 4.57 | 4.55 | 4.56 |
| | R1080U - 37% | | | |
| Example 3 | Anatase TiO₂ grafted | 4.71 | 5.3 | 5.66 |
| | R1080U - 46% | | | |
| Example 4 | Physical Blend of | 2.91 | 2.65 | 2.44 |
| | R1080U/T595 - 46% | | | |

TABLE 6
Percentage Improvement of NIR Reflectance % at Specific Wavelengths

| | | TiO₂/ | | | |
|---|---|---|---|---|---|
| Example | Description | CB wt. ratio | 905 nm | 1550 nm | 2000 nm |
| Example 1 | RAVEN 1080 ULTRA | 0/100 | 100% | 100% | 100% |
| | (“R1080U”) | | | | |
| Example 2 | Anatase TiO₂ grafted | 37/63 | 184% | 204% | 206% |
| | R1080U - 37% | | | | |
| Example 3 | Anatase TiO₂ grafted | 46/54 | 190% | 238% | 256% |
| | R1080U - 46% | | | | |
| Example 4 | Physical Blend of | 45/54 | 120% | 119% | 110% |
| | R1080U/T595 - 46% | | | | |

As shown in Tables 7 and 8, similar results were seen with additional Examples. The NIR reflectance % increases with the percentage of TiO₂ coating on the surface of RAVEN 1080 ULTRA (“R1080U”) as demonstrated by Examples 6 and 10.

TiO₂ grafted RAVEN 1080 ULTRA (“R1080U”) pigment showed significantly better improvement in NIR reflectance % than the physical blend of RAVEN 1080 ULTRA (“R1080U”)/TiO₂, regardless of the TiO₂ crystal type. Example 8 demonstrates about 180% higher NIR reflectance % than Example 5. The NIR reflectance % of Example 9 is 64% higher than that of Example 5.

At the same ratio of TiO₂ and carbon black, rutile TiO₂ grafted RAVEN 1080 ULTRA (“R1080U”) can achieve more significant NIR reflectance improvement than anatase TiO₂ grafted RAVEN 1080 ULTRA (“R1080U”) as demonstrated by Example 6 and 8.

TABLE 7
Percentage Improvement of NIR Reflectance % at Specific Wavelengths

| | | TiO₂/CB | | | |
|---|---|---|---|---|---|
| Example | Description | wt. ratio | 905 nm | 1550 nm | 2000 nm |
| Example 5 | RAVEN 1080 ULTRA | 0/100 | 100% | 100% | 100% |
| | (“R1080U”) | | | | |
| Example 6 | Anatase TiO₂ grafted | 80/20 | 180% | 160% | 171% |
| | R1080U- 80% | | | | |
| Example 7 | physical blend of | 80/20 | 147% | 147% | 142% |
| | R1080U/anatase TiO₂-80% | | | | |
| Example 8 | Rutile TiO₂ grafted | 80/20 | 279% | 229% | 247% |
| | R1080U- 80%, | | | | |
| Example 9 | Physical blend of | 80/20 | 164% | 148% | 139% |
| | R1080U/rutile TiO₂-80% | | | | |
| Example 10 | Anatase TiO₂ grafted | 90/10 | 294% | 383% | 478% |
| | R1080U- 90% | | | | |
| Example 11 | Physical blend of | 90/10 | 253% | 269% | 320% |
| | R1080U/anatase TiO₂-90% | | | | |

TABLE 8
Color of Acrylic Coating Containing Various Pigments.

| | | TiO₂/CB wt. | | | | |
|---|---|---|---|---|---|---|
| Example | Description | ratio | My | L | a | b |
| Example 5 | RAVEN 1080 ULTRA | 0/100 | 234 | 6.74 | −0.06 | −0.04 |
| | (“R1080U”) | | | | | |
| Example 6 | Anatase TiO₂ grafted | 80/20 | 189 | 11.32 | −0.01 | −2.50 |
| | R1080U-80% | | | | | |
| Example 7 | Physical blend of | 80/20 | 203 | 9.64 | 0.10 | −1.19 |
| | R1080U/anatase TiO₂- | | | | | |
| | 80% | | | | | |
| Example 8 | Rutile TiO₂ grafted | 80/20 | 163 | 15.26 | −0.07 | −2.07 |
| | R1080U-80% | | | | | |
| Example 9 | Physical blend of | 80/20 | 186 | 11.81 | −0.03 | −1.68 |
| | R1080U/rutile TiO₂-80% | | | | | |
| Example 10 | Anatase TiO₂ grafted | 90/10 | 152 | 17.39 | −0.19 | −3.14 |
| | R1080U-90% | | | | | |
| Example 11 | Physical blend of | 90/10 | 157 | 16.40 | −0.08 | −1.93 |
| | R1080U/anatase TiO₂- | | | | | |
| | 90% | | | | | |

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other methods and systems for carrying out the several purposes of this disclosure. As a result, the claims should not be considered as limited by the description or Examples.

What is claimed is:

1. A near-infrared reflective carbon black composite comprising a carbon black and a TiO₂ layer at least partially coating the carbon black.

2. The composite of claim 1, wherein the carbon black has an oil absorption number (OAN) ranging from 45-260 cm³/100 g.

3. The composite of claim 1, wherein the carbon black has a nitrogen surface area (NSA) ranging from 25-600 m²/g.

4. The composite of claim 1, which is free of transition metals other than Ti.

5. The composite of claim 1, which is free of iron and chromium.

6. The composite of claim 1, wherein the TiO₂ layer has an average thickness ranging from 0.5 nm to 200 nm.

7. (canceled)

8. The composite of claim 1, having a median particle size ranging from 0.1 μm to 5 μm.

9. (canceled)

10. (canceled)

11. A method for making a carbon black composite, the method comprising:
a) providing a carbon black having an oligomer coating comprising a Ti compound on at least a portion of the surface of the carbon black; and
b) converting the oligomer coating comprising the Ti compound to TiO₂ to form the carbon black composite.

12. (canceled)

13. (canceled)

14. The method of claim 11, wherein the Ti compound is formed from TiO₂ precursor.

15. The method of claim 14, wherein the TiO₂ precursor is a titanium alkoxide.

16. The method of claim 15, wherein the titanium alkoxide is titanium ethoxide, titanium propoxide, titanium isopropoxide, titanium butoxide, or a mixture thereof.

17. The method of claim 11, wherein the Ti compound is prepared from a precursor derived from a titanium sulphate, a titanium oxychloride, a titanium tetrachloride, a titanium (III) chloride, or a mixture thereof.

18. The method of claim 11, wherein the Ti compound is a condensation product of a titanic acid.

19. A method for making a carbon black composite, the method comprising:
a) providing a dispersion of a carbon black in a solvent;
b) mixing the dispersion with water and a TiO₂ precursor under conditions sufficient to form an oligomer coating comprising a Ti compound on at least a portion of the surface of the carbon black, wherein the TiO₂ precursor is at least partially soluble in the solvent; and
c) converting the oligomer coating comprising the Ti compound to TiO₂ to form the carbon black composite.

20. (canceled)

21. (canceled)

22. The method of claim 19, wherein the TiO₂ precursor is a titanium alkoxide.

23. The method of claim 22, wherein the titanium alkoxide is titanium ethoxide, titanium propoxide, titanium isopropoxide, titanium butoxide, or a mixture thereof.

24. The method of claim 19, wherein the TiO₂ precursor is a titanium sulphate, a titanium oxychloride, a titanium tetrachloride, a titanium (III) chloride, or a mixture thereof.

25. The method of claim 19, wherein the molar ratio of water to TiO₂ precursor ranges from 2:1 to 10:1.

26. The method of claim 19, wherein the molar ratio of water to TiO₂ precursor is about 3:1.

27. The method of claim 19, wherein the Ti compound is a condensation product of a titanic acid.
